(19) United States
(12) Patent Application Publication
(10) Pub. No.: US 2025/0129524 A1
(43) Pub. Date: Apr. 24, 2025

(54) PLASTIC OPTICAL FIBER AND METHOD FOR MANUFACTURING THE SAME

(71) Applicant: NITTO DENKO CORPORATION, Ibaraki-shi, Osaka (JP)

(72) Inventors: Chie KITANO, Osaka (JP); Tomoya KATO, Osaka (JP)

(73) Assignee: NITTO DENKO CORPORATION, Ibaraki-shi, Osaka (JP)

(21) Appl. No.: 18/836,598

(22) PCT Filed: Feb. 10, 2022
(86) PCT No.: PCT/JP2022/005506

§ 371 Date: Aug. 7, 2024

(30) Foreign Application Priority Data
Jan. 29, 2021 (JP) 2021-013987

(51) Int. Cl. D01F 8/16; C08L 27/18; C08L 71/02; D01F 8/10; G02B 1/04; G02B 6/036

(52) U.S. Cl. CPC D01F 8/16; C08L 27/18; C08L 71/02; D01F 8/10; G02B 1/048; G02B 6/036; C08L 2203/16; C08L 2205/06; D10B 2321/042; D10B 2331/06; D10B 2401/20

(57) ABSTRACT

A plastic optical fiber includes: a core; and a cladding disposed on an outer circumference of the core. The cladding includes a fluorine-containing resin including: a fluorine-containing polymer; and a fluorine-containing plasticizer, the fluorine-containing polymer having an amorphous structure, the fluorine-containing polymer including a structural unit (A) represented by the following formula (1):

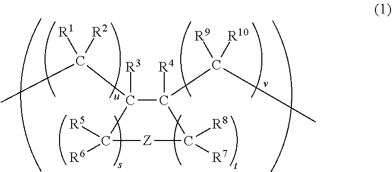

where Z represents an oxygen atom, a single bond, or —OC(R¹¹R¹²)O—; R¹ to R¹² each independently represent a fluorine atom, a perfluoroalkyl group having 1 to 5 carbon atoms, or a perfluoroalkoxy group having 1 to 5 carbon atoms; one or some of the fluorine atoms are each optionally substituted; s and t are each independently 0 to 5; and s+t is an integer of 1 to 6 or, in the case where Z is —OC(R¹¹R¹²)O—, s+t is optionally 0; and u and v are each independently 0 or 1.

### TECHNICAL FIELD

The present invention relates to a plastic optical fiber and a method for manufacturing the plastic optical fiber.

### BACKGROUND ART

Plastic optical fibers include a core, which is a light transmitting portion, located in a central portion and a cladding coating an outer circumference of the core. The core is made of a resin material having a high refractive index. The cladding is made of a resin material having a lower refractive index than that of the resin material of the core so that light will stay within the core.

Studies have been made for various configurations of plastic optical fibers in order to improve, for example, properties, such as transparency, and reduction in transmission loss. For example, Patent Literature 1 discloses a plastic optical fiber including a core and a cladding, the core being produced by shaping a melt of a crystalline perfluoro resin and then stretching the shaped melt, the cladding being formed of a perfluoro resin layer having a lower refractive index than that of the core.

### CITATION LIST

### Patent Literature

Patent Literature 1: JP 2003-322729 A

### SUMMARY OF INVENTION

### Technical Problem

A plastic optical fiber having a low transmission loss and an excellent capability is achieved, for example, by ensuring that light stays within the core. Therefore, selection of a cladding material is important. A cladding material is required to satisfy properties, such as transparency, required of a plastic optical fiber and also to have a lower refractive index than that of a core material of the plastic optical fiber. Moreover, in the case where the cladding is composed of a plurality of layers as in a double-cladding structure, the material of an outer cladding layer is required to have a much lower refractive index than that of the core material. As described above, there are many restrictions on cladding materials.

Plastic optical fibers are, for example, spun by a melt spinning technique. Specifically, a plastic optical fiber is spun by extruding a molten core material into a fiber shape and then extruding a molten cladding material to coat the surface of the fiber-shaped extrusion-molded body. To spin a plastic optical fiber by such a melt spinning method, the core material and the cladding material in a molten state are required, under a temperature condition during melt spinning, to have a viscosity (melt viscosity) in a range where melt extrusion thereof into a fiber shape is achievable. As described above, there is a restriction on cladding materials in terms of the manufacturing method as well. Even if a material having a capability that is excellent as a cladding material is discovered, the material is unusable as a cladding material unless the material has a melt viscosity in a range where melt extrusion thereof is achievable, the capability being demonstrated by a high transparency, a refractive index sufficiently lower than that of a core material, a high thermal resistance, and the like.

Therefore, the present invention aims to provide a plastic optical fiber including a cladding made of a material that makes properties required of the cladding achievable and that makes melt spinning feasible. The present invention also aims to provide a plastic optical fiber manufacturing method by which a cladding can be produced by melt spinning using a material that makes properties required of the cladding achievable.

### Solution to Problem

A plastic optical fiber according to a first aspect of the present invention includes: a core; and
a cladding disposed on an outer circumference of the core, wherein
the cladding includes a fluorine-containing resin including: a fluorine-containing polymer; and a fluorine-containing plasticizer, the fluorine-containing polymer having an amorphous structure, the fluorine-containing polymer including a structural unit (A) represented by the following formula (1):

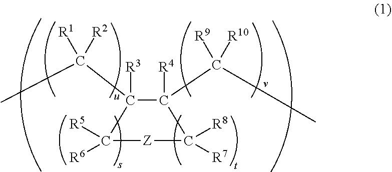

where Z represents an oxygen atom, a single bond, or —OC(R¹¹R¹²)O—; R¹ to R¹² each independently represent a fluorine atom, a perfluoroalkyl group having 1 to 5 carbon atoms, or a perfluoroalkoxy group having 1 to 5 carbon atoms; one or some of the fluorine atoms are each optionally substituted by a halogen atom other than a fluorine atom; one or some of fluorine atoms in the perfluoroalkyl group are each optionally substituted by a halogen atom other than a fluorine atom; one or some of fluorine atoms in the perfluoroalkoxy group are optionally substituted by a halogen atom other than a fluorine atom; s and t are each independently 0 to 5; and s+t is an integer of 1 to 6 or, in the case where Z is —OC(R¹¹R¹²)O—, s+t is optionally 0; and u and v are each independently 0 or 1, and
the fluorine-containing resin has a viscosity of 6000 Pa·s or less at 270° C. and a shear rate of 0.05 s⁻¹.

A plastic optical fiber manufacturing method according to a second aspect of the present invention is a method for manufacturing the above plastic optical fiber according to the first aspect, the method including:
producing a fiber-shaped extrusion-molded body by melting a first preform and extruding the molten first preform into a fiber shape, the first preform including a core material, the fiber-shaped extrusion-molded body being made of a core material; and
coating a surface of the extrusion-molded body with a second preform by melting the second preform and extruding the molten second preform, the second preform including a cladding material, wherein
the cladding material is the fluorine-containing resin.

### Advantageous Effects of Invention

The present invention can provide a plastic optical fiber including a cladding made of a material that makes properties required of the cladding achievable and that makes melt spinning feasible and the method for manufacturing the plastic optical fiber.

### BRIEF DESCRIPTION OF DRAWINGS

FIG. 1 is a schematic diagram showing an example of a cross-sectional structure of a plastic optical fiber of the present invention.

FIG. 2 is a schematic diagram showing another example of the cross-sectional structure of the plastic optical fiber of the present invention.

FIG. 3 is a schematic diagram showing yet another example of the cross-sectional structure of the plastic optical fiber of the present invention.

### DESCRIPTION OF EMBODIMENTS

An embodiment of a plastic optical fiber (hereinafter referred to as “POF”) of the present invention will be described. The POF according to the present embodiment includes a core and a cladding disposed on an outer circumference of the core. The POF according to the present embodiment is, for example, a graded-index (GI) POF.

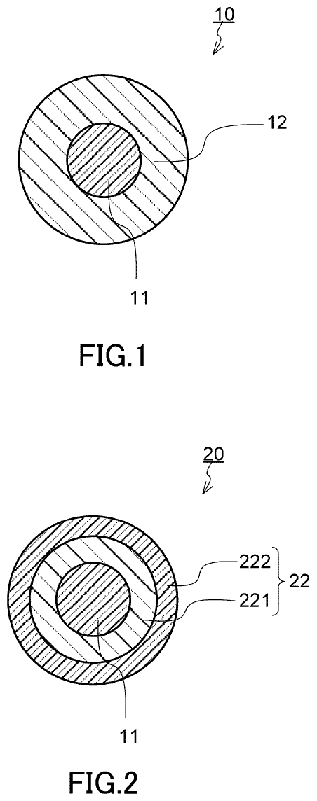

FIG. 1 shows an example of a cross-sectional structure of the POF according to the present embodiment.

A POF 10 shown in FIG. 1 includes a core 11 and a cladding 12 disposed on an outer circumference of the core 11.

In the POF 10 according to the present embodiment, the cladding 12 includes a fluorine-containing resin. This fluorine-containing resin includes a fluorine-containing polymer and a fluorine-containing plasticizer, the fluorine-containing polymer including a structural unit (A) represented by the following formula (1), the fluorine-containing polymer having an amorphous structure. This fluorine-containing resin has a viscosity of 6000 Pa·s or less at 270° C. and a shear rate of 0.05 s⁻¹. Hereinafter, the fluorine-containing resin included in the cladding 12 is referred to as “first fluorine-containing resin”, and the fluorine-containing polymer included in the first fluorine-containing resin is referred to as “first fluorine-containing polymer”.

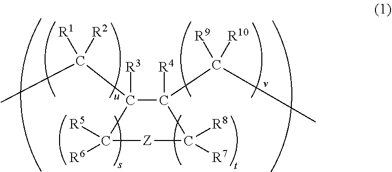

(In the formula (1), Z represents an oxygen atom, a single bond, or —OC(R¹¹R¹²)O—, and R¹ to R¹² each independently represent a fluorine atom, a perfluoroalkyl group having 1 to 5 carbon atoms, or a perfluoroalkoxy group having 1 to 5 carbon atoms. “Perfluoro” indicates that every hydrogen atom bonded to a carbon atom is substituted by a fluorine atom. One or some of the fluorine atoms are each optionally substituted by a halogen atom other than a fluorine atom. One or some of fluorine atoms in the perfluoroalkyl group are each optionally substituted by a halogen atom other than a fluorine atom. One or some of fluorine atoms in the perfluoroalkoxy group are each optionally substituted by a halogen atom other than a fluorine atom. The symbols s and t are each independently 0 to 5, and s+t is an integer of 1 to 6 or, in the case where Z is —OC(R¹¹R¹²)O—, s+t is optionally 0. The symbols u and v are each independently 0 or 1.)

Since having an amorphous structure, the first fluorine-containing polymer including the structural unit (A) represented by the above formula (1) can contributing to achievement of a high transparency and may contribute to achievement of a low refractive index. The first fluorine-containing resin, which is obtained by mixing the fluorine-containing plasticizer into the first fluorine-containing polymer, has a viscosity of 6000 Pa·s or less at 270° C. and a shear rate of 0.05 s⁻¹ while almost fully maintaining the above excellent properties of the first fluorine-containing polymer. Hence, the first fluorine-containing resin is a material that makes properties required of the cladding achievable and that makes melt spinning feasible. The first fluorine-containing resin is excellent, for example, as a material of a cladding of a GI POF. Hence, the POF 10 according to the present embodiment includes the cladding 12 having excellent properties and can be produced by melt spinning. The viscosity of the first fluorine-containing resin at 270° C. and a shear rate of 0.05 s⁻¹ is preferably 5000 Pa·s or less and more preferably 2000 Pa·s or less so that the POF 10 having a uniform diameter can be formed by melt spinning. The viscosity of the first fluorine-containing resin at 270° C. and a shear rate of 0.05 s⁻¹ is only required to be in a range where melt spinning is achievable. Therefore, the lower limit of the viscosity is not limited to a particular value. The lower limit thereof is, for example, 50 Pa·s or more. Here, the viscosity of the first fluorine-containing resin at 270° C. and a shear rate of 0.05 s⁻¹ is a value measured by a rotational viscosity measurement method, and is measured using a rotational rheometer.

The constituents of the POF 10 according to the present embodiment will be described hereinafter in more detail.

### (Core 11)

The core 11 is a portion configured to transmit light. The core 11 has a higher refractive index than that of the cladding 12. Because of this, light incident on the core 11 is trapped inside the core 11 by the cladding 12 and propagates in the POF 10.

The material of the core 11 is not limited to a particular one as long as the material of the core 11 is a resin having a high transparency. Examples of the resin include fluorine-containing resins, acrylic resins such as methyl methacrylate, styrene resins, and carbonate resins. Among these, a fluorine-containing resin is suitably included because, in that case, a low transmission loss can be achieved in a wide wavelength region.

The material of the core 11 is preferably a fluorine-containing resin including a fluorine-containing polymer. Hereinafter, the fluorine-containing resin included in the core 11 is referred to as “second fluorine-containing resin, and the fluorine-containing polymer included in the second fluorine-containing resin is referred to as “second fluorine-containing polymer”.

It is preferred that the fluorine-containing polymer included in the second fluorine-containing resin be substantially free of a hydrogen atom from the viewpoint of reducing light absorption attributable to stretching energy of a C—H bond. It is particularly preferred that every hydrogen atom bonded to a carbon atom be substituted by a fluorine atom. That is, it is preferred that the second fluorine-containing polymer included in the second fluorine-containing resin be substantially free of a hydrogen atom and be fully fluorinated. Herein, saying that the fluorine-containing polymer is substantially free of a hydrogen atom means that the hydrogen atom content in the fluorine-containing polymer is 1 mol % or less.

The second fluorine-containing polymer preferably has a fluorine-containing aliphatic ring structure. The fluorine-containing aliphatic ring structure may be included in a main chain of the fluorine-containing polymer, or may be included in a side chain of the second fluorine-containing polymer. The second fluorine-containing polymer has, for example, a structural unit (G) represented by the following structural formula (7).

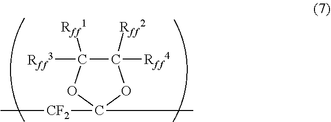

In the formula (7), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (7), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (7), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (G) include structural units represented by the following formulae (G1) to (G8).

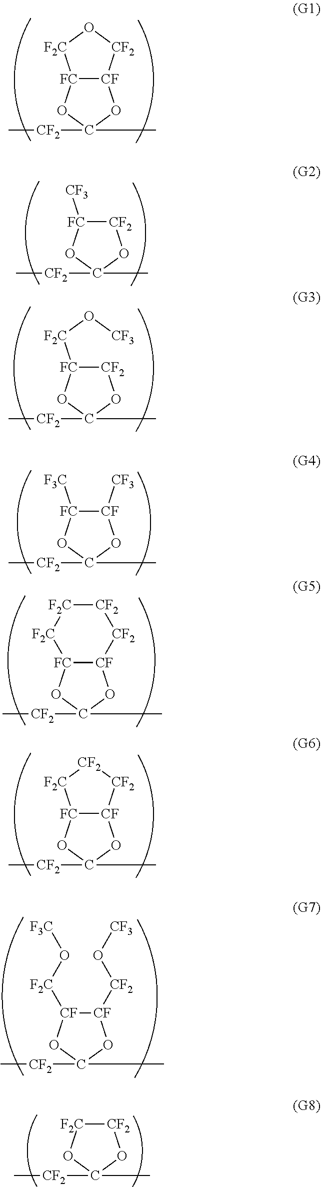

Among the structural units represented by the above formulae (G1) to (G8), the structural unit (G) is preferably the structural unit (G2), i.e., a structural unit represented by the following formula (8).

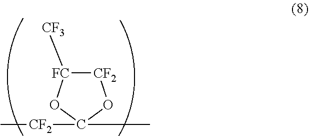

The second fluorine-containing polymer may include one or more structural units (G). In the fluorine-containing polymer, the amount of the structural unit (G) is preferably 20 mol % or more and more preferably 40 mol % or more of a total amount of all structural units. When including 20 mol % or more of the structural unit (G), the second fluorine-containing polymer tends to have much higher thermal resistance. When including 40 mol % or more of the structural unit (G), the second fluorine-containing polymer tends to have much higher transparency and much higher mechanical strength in addition to high thermal resistance. In the second fluorine-containing polymer, the amount of the structural unit (G) is preferably 95 mol % or less and more preferably 70 mol % or less of the total amount of all structural units.

The structural unit (G) is derived from, for example, a compound represented by the following formula (9). In the formula (9), R_{ff}¹ to R_{ff}⁴ are as described in the formula (7). It should be noted that the compound represented by the formula (9) can be obtained, for example, by an already-known manufacturing method such as a manufacturing method disclosed in JP 2007-504125 A.

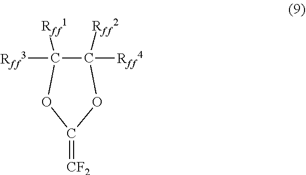

Specific examples of the compound represented by the above formula (9) include compounds represented by the following formulae (K1) to (K8).

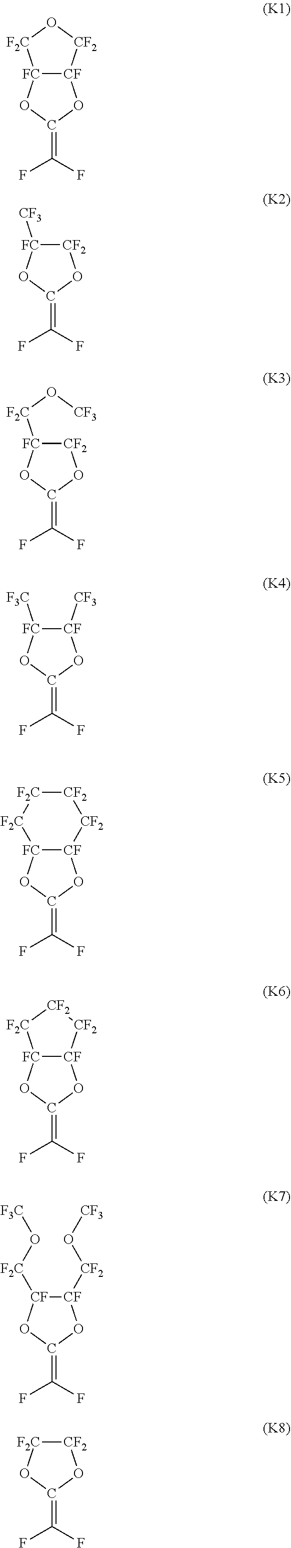

The fluorine-containing polymer may further include an additional structural unit other than the structural unit (G). Examples of the additional structural unit include the following structural units (H) to (J).

The structural unit (H) is represented by the following formula (10).

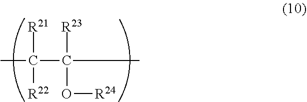

In the formula (10), R²¹ to R²³ each independently represent a fluorine atom or a perfluoroalkyl group having 1 to 7 carbon atoms. R²⁴ represents a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The fluorine-containing polymer may include one or more structural units (H). In the fluorine-containing polymer, the amount of the structural unit (H) is preferably 5 to 10 mol % of the total amount of all structural units. The amount of the structural unit (H) may be 9 mol % or less or 8 mol % or less.

The structural unit (H) is derived from, for example, a compound represented by the following formula (11). In the formula (11), R²¹ to R²³ are as described for the formula (10). The compound represented by the formula (11) is a fluorine-containing vinyl ether such as perfluorovinyl ether.

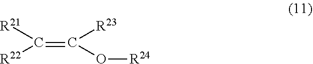

The structural unit (I) is represented by the following formula (12).

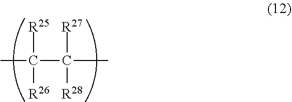

In the formula (12), R²⁵ to R²⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The fluorine-containing polymer may include one or more structural units (I). In the fluorine-containing polymer, the amount of the structural unit (I) is preferably 5 to 10 mol % of the total amount of all structural units. The amount of the structural unit (I) may be 9 mol % or less or 8 mol % or less.

The structural unit (I) is derived from, for example, a compound represented by the following formula (13). In the formula (13), R²⁵ to R²⁸ are as described for the formula (12). The compound represented by the formula (13) is a fluorine-containing olefin such as tetrafluoroethylene or chlorotrifluoroethylene.

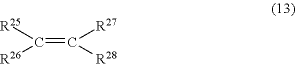

The structural unit (J) is represented by the following formula (14).

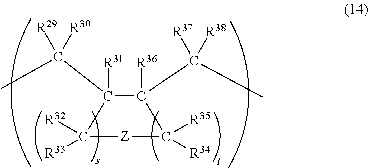

In the formula (14), Z represents an oxygen atom, a single bond, or —OC(R³⁹R⁴⁰)O—, R²⁹ to R⁴⁰ each independently represent a fluorine atom, a perfluoroalkyl group having 1 to 5 carbon atoms, or a perfluoroalkoxy group having 1 to 5 carbon atoms.

One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R³⁹R⁴⁰)O—, s+t may be 0).

The structural unit (J) is preferably represented by the following formula (15). The structural unit represented by the following formula (15) is a structural unit represented by the above formula (14), where Z is an oxygen atom, s is 0, and t is 2.

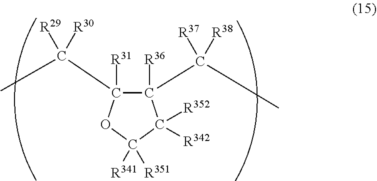

In the formula (15), R³⁴¹, R³⁴², R³⁵¹, and R³⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The fluorine-containing polymer may include one or more structural units (J). In the fluorine-containing polymer, the amount of the structural unit (J) is preferably 30 to 67 mol % of the total amount of all structural units. The amount of the structural unit (J) is, for example, 35 mol % or more, and may be 60 mol % or less or 55 mol % or less.

The structural unit (J) is, for example, derived from a compound represented by the following formula (16). In the formula (16), Z, R²⁹ to R³⁸, s, and t are as described for the formula (14). The compound represented by the formula (16) is a cyclopolymerizable fluorine-containing compound having two or more polymerizable double bonds.

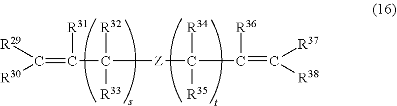

The structural unit (J) is preferably derived from a compound represented by the following formula (17). In the formula (17), R³⁴¹, R³⁴², R³⁵¹, and R³⁵² are as described for the formula (15).

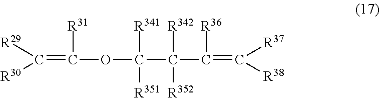

Specific examples of the compound represented by the formula (16) or the formula (17) include the following compounds.
CF₂=CFOCF₂CF=CF₂
CF₂=CFOCF(CF₃)CF=CF₂
CF₂=CFOCF₂CF₂CF=CF₂
CF₂=CFOCF₂CF(CF₃)CF=CF₂
CF₂=CFOCF(CF₃)CF₂CF=CF₂
CF₂=CFOCFClCF₂CF=CF₂
CF₂=CFOCCl₂CF₂CF=CF₂
CF₂=CFOCF₂OCF=CF₂
CF₂=CFOC(CF₃)₂OCF=CF₂
CF₂=CFOCF₂CF(OCF₃)CF=CF₂
CF₂=CFCF₂CF=CF₂
CF₂=CFCF₂CF₂CF=CF₂
CF₂=CFCF₂OCF₂CF=CF₂
CF₂=CFOCF₂CFClCF=CF₂
CF₂=CFOCF₂CF₂CCl=CF₂
CF₂=CFOCF₂CF₂CF=CFCl
CF₂=CFOCF₂CF(CF₃)CCl=CF₂
CF₂=CFOCF₂OCF=CF₂
CF₂=CFOCCl₂OCF=CF₂
CF₂=CClOCF₂OCCl=CF₂

The second fluorine-containing polymer may further include an additional structural unit other than the structural units (G) to (J). However, the second fluorine-containing polymer is preferably substantially free of an additional structural unit other than the structural units (G) to (J). Saying that the fluorine-containing polymer is substantially free of an additional structural unit other than the structural units (G) to (J) means that the sum of the amounts of the structural units (G) to (J) is 95 mol % or more and preferably 98 mol % or more of the total amount of all structural units in the fluorine-containing polymer.

The method for polymerizing the fluorine-containing polymer is not limited to a particular one, and a common polymerization method such as radical polymerization can be used. A polymerization initiator for the polymerization of the fluorine-containing polymer may be a fully-fluorinated compound.

A glass transition temperature Tg of the fluorine-containing polymer is, for example, but not particularly limited to, 100° C. to 140° C., and may be 105° C. or higher or 120° C. or higher.

The material of the core 11 may include the second fluorine-containing polymer as its main component, and preferably substantially consists of the first fluorine-containing polymer.

The material of the core 11 may further include an additive in addition to the second fluorine-containing polymer. The additive is, for example, a refractive index modifier. The refractive index modifier can be, for example, a known refractive index modifier used as the material of the core 11 of the POF 10. The material of the core 11 may include an additive other than the refractive index modifier.

In the case where the POF 10 of the present embodiment is, for example, a graded-index POF, the core 11 has a refractive-index distribution in which the refractive index varies in a radius direction. Such a refractive-index distribution can be formed, for example, by adding a refractive index modifier to the second fluorine-containing resin and diffusing the refractive index modifier in the second fluorine-containing resin (for example, by thermal diffusion).

The refractive index of the core 11 is not limited to a particular value as long as the refractive index of the core 11 is higher than the refractive index of the cladding 12. To achieve the POF 10 having a high numerical aperture, it is preferred that a difference between the refractive index of the core 11 and that of the cladding 12 be large at a wavelength of light used. For example, the refractive index of the core 11 can be 1.340 or more or even 1.360 or more at a wavelength (e.g., a wavelength of 848 nm) of light used. The upper limit of the refractive index of the core is, for example, but not particularly limited to, 1.4000 or less.

### (Cladding 12)

As described above, in the POF 10 according to the present embodiment, the cladding 11 includes the first fluorine-containing resin including: the first fluorine-containing polymer including the structural unit (A) represented by the above formula (1); and the fluorine-containing plasticizer. As described above, the first fluorine-containing polymer can contributing to achievement of a high transparency and may also contribute to achievement of a low refractive index. The first fluorine-containing resin includes the first fluorine-containing polymer having such excellent properties and the fluorine-containing plasticizer, and has a viscosity of 6000 Pa·s or less at 270° C. and a shear rate of 0.05 s⁻¹. Therefore, the first fluorine-containing resin makes properties required of the cladding achievable, and makes melt spinning feasible.

The first fluorine-containing polymer may further include a structural unit (B) represented by the following formula (2).

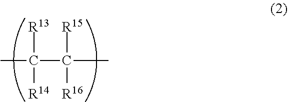

(In the formula (2), R¹³ to R¹⁶ each independently represent a fluorine atom or a perfluoroalkyl group having 1 to 7 carbon atoms. The perfluoroalkyl group optionally has a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.)

When the first fluorine-containing polymer is such a copolymer as described above, a ratio between the structural unit (A) and the structural unit (B) is any ratio, and is not limited to a particular one.

When the first fluorine-containing polymer is a copolymer including the structural unit (A) represented by the above formula (1) and the structural unit (B) represented by the above formula (2), a much lower refractive index can be achieved. The refractive index of the cladding 12 can be decreased further by using such a copolymer, and therefore the difference between the refractive index of the core 11 and that of the cladding 12 can be greater. Consequently, the function of the cladding 12 to trap light within the core 11 is improved, and the POF 10 having a low transmission loss is likely to be achieved.

The first fluorine-containing polymer is preferably, for example, at least one selected from the group consisting of a fluorine-containing polymer A and a fluorine-containing polymer B given below.

The fluorine-containing polymer A includes a structural unit (C) represented by the following formula (3) and a structural unit (D) represented by the following formula (4). In the following formula (3), R³, R⁴, R¹¹, and R¹² are as described in the above formula (1).

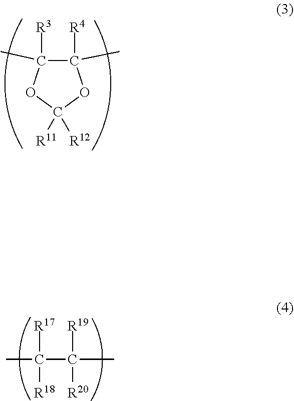

(In the formula (4), R¹⁷ to R²⁰ each independently represent a fluorine atom or a perfluoroalkyl group having 1 to 7 carbon atoms. The perfluoroalkyl group optionally has a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.)

The fluorine-containing polymer B includes a structural unit (E) represented by the following formula (5). In the following formula (5), R¹ to R⁴, R⁷ to R¹⁰, R¹¹, and R¹² are as described in the above formula (1).

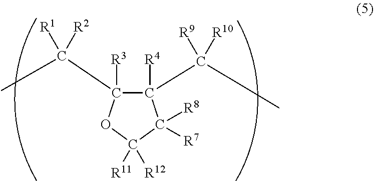

The fluorine-containing polymer A and the fluorine-containing polymer B have a very high transparency and can also have a very low refractive index compared to a common refractive index of the second fluorine-containing resin used as the material of the core 11. Therefore, the first fluorine-containing resin including at least one selected from the group consisting of the fluorine-containing polymer A and the fluorine-containing polymer B as the first fluorine-containing polymer can further decrease the refractive index without sacrificing the high transparency of the cladding 12. This can further increase the difference between the refractive index of the core 11 and that of the cladding 12; consequently, the function of the cladding 12 to trap light within the core 11 is further improved, and the POF 10 having a low transmission loss is likely to be achieved.

The first fluorine-containing polymer preferably includes a structural unit (F) represented by the following formula (6).

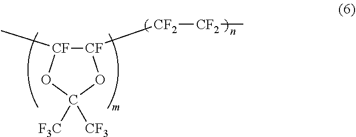

(In the formula (6), m and n are each an integer.)

When the first fluorine-containing polymer is a polymer including the structural unit (F), the first fluorine-containing polymer has a very high transparency and can also have a very low refractive index compared to a common refractive index of the second fluorine-containing resin used as the material of the core 11. Therefore, when the first fluorine-containing polymer is a polymer including the structural unit (F), the first fluorine-containing resin can further decrease the refractive index without sacrificing the high transparency of the cladding 12. This can further increase the difference between the refractive index of the core 11 and that of the cladding 12; consequently, the function of the cladding 12 to trap light within the core 11 is further improved, and the POF 10 having a low transmission loss is likely to be achieved.

The fluorine-containing plasticizer is preferably a fluorine-containing polyether, and is more preferably a perfluoropolyether.

Specific examples of the perfluoropolyether include organic compounds represented by the following formula (19) or (20). In the following formulae (19) and (20), p1, q1, p2, and q2 are each an integer.

CF₃—[(O(CF₃)CFCF₂)ₚ₁—(OCF₂)_{q1}]OCF₃ (19)

CF₃—[(OCF₂CF₂)ₚ₂—(OCF₂)_{q2}]OCF₃ (20)

The first fluorine-containing resin has a high transparency.

The refractive index of the first fluorine-containing resin is not limited to a particular value as long as the refractive index of the first fluorine-containing resin is determined on the basis of the refractive index of the material of the core 11. When the refractive index of the core 11 of the present embodiment is, for example, 1.346 or more at a wavelength (for example, a wavelength of 848 nm) of light used, the first fluorine-containing resin preferably has a refractive index of 1.345 or less at a wavelength of 848 nm, and more preferably has a refractive index of 1.325 or less. When the first fluorine-containing resin has a refractive index of 1.325 or less, the cladding 12 having a refractive index greatly different from that of the core 11 can be achieved; consequently, the function of the cladding 12 to trap light within the core 11 is improved, and the POF 10 having a low transmission loss is likely to be achieved.

FIG. 2 shows a modification of the POF according to the present embodiment. In the POF 20 of the modification shown in FIG. 2, the cladding 12 of the POF 10 shown in FIG. 1 is replaced with a cladding 22 including a plurality of layers. The cladding 22 of the POF 20 has a double-cladding structure, which is a two-layer structure composed of a first cladding layer 221 disposed in contact with the core 11 and a second cladding layer 222 disposed closer to an outer circumference of the POF 20 than the first cladding layer 221 is. In the case of this structure, for example, the second cladding layer 222 preferably includes the first fluorine-containing resin. The second cladding layer 222 is required to have a lower refractive index than that of the first cladding layer 221. As described above, the first fluorine-containing resin can contribute to achievement of a very low refractive index relative to that of the material of the core 11. Therefore, the first fluorine-containing resin can be included in the second cladding layer 222 of the POF 20. The cladding 22 in the example shown in FIG. 2 has a two-layer structure; however, the number of layers in the cladding 22 is not limited to two, and the cladding 22 may include three or more layers. In the case where the cladding is composed of a plurality of layers, for example, even when light incident on the core fails to be totally reflected at the interface between the core and the cladding and leaks to the cladding side, the leaked light can be totally reflected by a cladding layer closer to the outer circumference and thus an optical loss can be reduced.

A proportion of the first fluorine-containing plasticizer to a sum of the first fluorine-containing polymer and the first fluorine-containing plasticizer can be determined as appropriate according to an aimed refractive index, melt viscosity, etc. For example, to decease the melt viscosity of the first fluorine-containing resin to a range where melt spinning is achievable without sacrificing the transparency and the refractive index of the first fluorine-containing polymer, the proportion of the first fluorine-containing plasticizer to the sum of the first fluorine-containing polymer and the first fluorine-containing plasticizer is preferably 3 mass % or more and 60 mass % or less, and more preferably 5 mass % or more and 50 mass % or less. The proportion of the first fluorine-containing plasticizer to the sum of the first fluorine-containing polymer and the first fluorine-containing plasticizer is even more preferably 10 mass % or more, and particularly preferably 20 mass % or more. The proportion of the first fluorine-containing plasticizer to the sum of the first fluorine-containing polymer and the first fluorine-containing plasticizer is even more preferably 40 mass % or less, and particularly preferably 30 mass % or less.

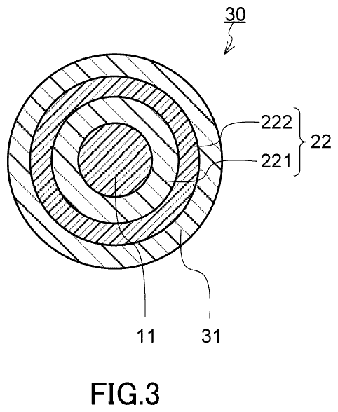

FIG. 3 shows another modification of the POF according to the present embodiment. In a POF 30 shown in FIG. 3, the POF 20 is further provided with a coating layer 31 disposed on an outer circumference of the cladding 22. The coating layer 31 is provided to improve the mechanical strength of the POF 30. The coating layer 31 is provided to improve the mechanical strength of the POF. For example, materials (such as polycarbonate, various engineering plastics, cycloolefin polymers, PTFE, modified PTFEs, and PFAs) and structures of coating layers in known POFs can be applied to the coating layer 31. The coating layer 31 may be provided on the outer circumference of the cladding 12 of the POF 10 shown in FIG. 1.

### (POF Manufacturing Method)

The POF of the present embodiment can be manufactured by melt spinning. That is, the POF manufacturing method of the present embodiment includes:
producing a fiber-shaped extrusion-molded body by melting a first preform and extruding the molten first preform into a fiber shape, the first preform including a core material, the fiber-shaped extrusion-molded body being made of the core material; and
coating a surface of the extrusion-molded body with a second preform by melting the second preform and extruding the molten second preform, the second preform including a cladding material. The cladding material is the first fluorine-containing resin.

As described above, the first fluorine-containing resin according to the present embodiment has a viscosity of 6000 Pa·s or less at 270° C. and a shear rate of 0.05 s⁻¹. In the present embodiment, melt spinning of the core material and the cladding material is performed, for example, in the temperature range of 200 to 320° C. Since having the above melt viscosity, the first fluorine-containing resin according to the present embodiment makes melt spinning in the above temperature range achievable.

### EXAMPLES

### Example 1

### Production of First Fluorine-Containing Resin

Teflon (registered trademark) AF1600 (manufactured by Chemours-Mitsui Fluoroproducts Co., Ltd.) was used as the first fluorine-containing polymer. Teflon (registered trademark) AF1600 is a fluorine-containing polymer including the structural unit (F) represented by the above formula (6). Fomblin (YR grade, manufactured by Solvay) was used as the fluorine-containing plasticizer. Fomblin YR used is represented by the above formula (19). Teflon (registered trademark) AF1600 and Fomblin YR were mixed such that Fomblin YR accounted for 5 mass %. The resulting mixture was evaluated for the melt viscosity at 270° C. and a shear rate of 0.05 s⁻¹, the refractive index for light with a wavelength of 848 nm, and the transparency by the methods described below.

### [Measurement of Melt Viscosity]

The melt viscosity at 270° C. was measured for the first fluorine-containing resin produced as described above. A rotational rheometer “HAAKE MARS III” (manufactured by Thermo Fisher Scientific K.K.) was used as a measurement apparatus. Measurement settings of the apparatus were as follows.

Measurement settings of apparatus:
Geometry: The cone and the plate each had a diameter of 20 mmφ (inclination angle: 4°). The plate used was made of Ti.
Shear rate: The shear rate was varied uninterruptedly from 0.01 [1/s] to 5 [1/s], and the melt viscosity at 0.05 [1/s] was read. Prerotation was performed for up to 2 minutes at 0.01 [1/s]. The measurement time was 10 minutes.
Plate-to-plate distance: 0.140 mm; volume: 0.150 cm³

A specimen was dried at 100° C. for 10 hours or longer before measured. The measurement of the melt viscosity of the specimen was started within 15 minutes after the end of the drying. To stabilize the specimen, the specimen was placed on a stage heated at 270° C. and left for about 10 minutes before the start of the measurement. Table 1 shows the result.

### [Measurement of Refractive Index]

The refractive index of the first fluorine-containing resin was measured by the following method. A specimen was pressed at 210° C. to give a 150 μm-thick sheet. The refractive index for light with a wavelength of 848 nm was measured for the obtained sheet with a prism coupler. Table 1 shows the results.

### Evaluation of Transparency

The sheet used for the refractive index measurement was visually observed for cloudiness.

### Example 2

### Production of First Fluorine-Containing Resin

A first fluorine-containing resin of Example 2 was produced in the same manner as in Example 1, except that Fomblin YR and Teflon (registered trademark) AF1600 were mixed such that Fomblin YR accounted for 10 mass %. The first fluorine-containing resin of Example 2 was evaluated in the same manner as in Example 1 for the melt viscosity at 270° C. and a shear rate of 0.05 s⁻¹, the refractive index for light with a wavelength of 848 nm, and the transparency. Table 1 shows the results.

### Example 3

### Production of First Fluorine-Containing Resin

A first fluorine-containing resin of Example 3 was produced in the same manner as in Example 1, except that Fomblin YR and Teflon (registered trademark) AF1600 were mixed such that Fomblin YR accounted for 20 mass %. The first fluorine-containing resin of Example 3 was evaluated in the same manner as in Example 1 for the melt viscosity at 270° C. and a shear rate of 0.05 s⁻¹, the refractive index for light with a wavelength of 848 nm, and the transparency. Table 1 shows the results.

### Example 4

### Production of First Fluorine-Containing Resin

A first fluorine-containing resin of Example 4 was produced in the same manner as in Example 1, except that Fomblin YR and Teflon (registered trademark) AF1600 were mixed such that Fomblin YR accounted for 30 mass %. The first fluorine-containing resin of Example 4 was evaluated in the same manner as in Example 1 for the melt viscosity at 270° C. and a shear rate of 0.05 s⁻¹, the refractive index for light with a wavelength of 848 nm, and the transparency. Table 1 shows the results.

### Example 5

### Production of First Fluorine-Containing Resin

A first fluorine-containing resin of Example 5 was produced in the same manner as in Example 1, except that Fomblin YR and Teflon (registered trademark) AF1600 were mixed such that Fomblin YR accounted for 50 mass %. The first fluorine-containing resin of Example 5 was evaluated in the same manner as in Example 1 for the melt viscosity at 270° C. and a shear rate of 0.05 s⁻¹, the refractive index for light with a wavelength of 848 nm, and the transparency. Table 1 shows the results.

### Example 6

### Production of First Fluorine-Containing Resin

A first fluorine-containing resin of Example 6 was produced in the same manner as in Example 1, except that Fomblin (M60 grade, manufactured by Solvay) was used as the fluorine-containing plasticizer. Fomblin M60 used is represented by the above formula (20). The first fluorine-containing resin of Example 6 was evaluated in the same manner as in Example 1 for the melt viscosity at 270° C. and a shear rate of 0.05 s⁻¹, the refractive index for light with a wavelength of 848 nm, and the transparency. Table 1 shows the results.

### Comparative Example 1

### Production of First Fluorine-Containing Resin

A first fluorine-containing resin of Comparative Example 1 was produced in the same manner as in Example 1, except that Fomblin YR was not added. That is, the first fluorine-containing resin of Comparative Example 1 consisted of Teflon (registered trademark) AF1600. The first fluorine-containing resin of Comparative Example 1 was evaluated in the same manner as in Example 1 for the melt viscosity at 270° C. and a shear rate of 0.05 s⁻¹, the refractive index for light with a wavelength of 848 nm, and the transparency. Table 1 shows the results.

TABLE 1

| First fluorine- | Example | | | | | | Comparative |
|---|---|---|---|---|---|---|---|
| containing resin | 1 | 2 | 3 | 4 | 5 | 6 | Example 1 |
| Fluorine- | Fomblin | Fomblin | Fomblin | Fomblin | Fomblin | Fomblin | — |
| containing | YR | YR | YR | YR | YR | M60 | |
| plasticizer | | | | | | | |
| Proportion of | 5 | 10 | 20 | 30 | 50 | 10 | 0 |
| fluorine- | | | | | | | |
| containing | | | | | | | |
| plasticizer | | | | | | | |
| (mass %) | | | | | | | |
| Average | 6,400 | 6,400 | 6,400 | 6,400 | 6,400 | 18,700 | — |
| molecular | | | | | | | |
| weight of | | | | | | | |
| fluorine- | | | | | | | |
| containing | | | | | | | |
| plasticizer | | | | | | | |
| Melt viscosity | 5049 | 2567 | 1205 | 516 | 70 | 4830 | 9367 |
| at 270° C. and | | | | | | | |
| 0.05 s⁻¹ (Pa · s) | | | | | | | |
| Refractive index | 1.315 | 1.317 | 1.321 | 1.324 | 1.332 | 1.315 | 1.308 |
| Transparency | Transparent | Transparent | Transparent | Transparent | Transparent | Transparent | Transparent |

The first fluorine-containing resins of Examples 1 to 6 each include: the fluorine-containing polymer including the structural unit (A) represented by the formula (1); and the fluorine-containing plasticizer, and also satisfy a viscosity of 6000 Pa·s or less at 270° C. and a shear rate of 0.05 s⁻¹. Furthermore, the first fluorine-containing resins of Examples 1 to 6 each have a low refractive index and a high transparency. Therefore, the first fluorine-containing resins of Examples 1 to 6 are each suitable as a material of a cladding of a POF produced by melt spinning. On the other hand, although having a low refractive index and an excellent transparency, the first fluorine-containing resin of Comparative Example 1 not including a fluorine-containing plasticizer has such a high melt viscosity at 270° C. and a shear rate of 0.05 s⁻¹ that the first fluorine-containing resin of Comparative Example 1 is unusable as a material of a cladding of a POF produced by melt spinning.

### INDUSTRIAL APPLICABILITY

The POF of the present invention can achieve a low transmission loss and is suitable for use in high-speed communication.

1. A plastic optical fiber comprising:
a core; and
a cladding disposed on an outer circumference of the core, wherein
the cladding includes a fluorine-containing resin including: a fluorine-containing polymer;
and a fluorine-containing plasticizer, the fluorine-containing polymer having an amorphous structure, the fluorine-containing polymer including a structural unit (A) represented by the following formula (1): 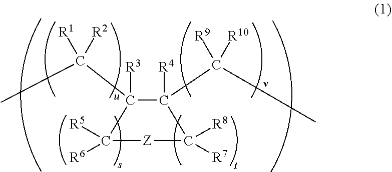
where Z represents an oxygen atom, a single bond, or —OC(R¹¹R¹²)O—; R¹ to R¹² each independently represent a fluorine atom, a perfluoroalkyl group having 1 to 5 carbon atoms, or a perfluoroalkoxy group having 1 to 5 carbon atoms; one or some of the fluorine atoms are each optionally substituted by a halogen atom other than a fluorine atom; one or some of fluorine atoms in the perfluoroalkyl group are each optionally substituted by a halogen atom other than a fluorine atom; one or some of fluorine atoms in the perfluoroalkoxy group are optionally substituted by a halogen atom other than a fluorine atom; s and t are each independently 0 to 5; and s+t is an integer of 1 to 6 or, in the case where Z is —OC(R¹¹R¹²)O—, s+t is optionally 0; and u and v are each independently 0 or 1, and
the fluorine-containing resin has a viscosity of 6000 Pa·s or less at 270° C. and a shear rate of 0.05 s⁻¹.

2. The plastic optical fiber according to claim 1, wherein the fluorine-containing polymer further includes a structural unit (B) represented by the following formula (2): 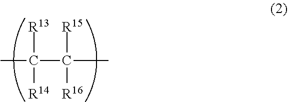
where R¹³ to R¹⁶ each independently represent a fluorine atom or a perfluoroalkyl group having 1 to 7 carbon atoms; the perfluoroalkyl group optionally has a ring structure; one or some of the fluorine atoms are each optionally substituted by a halogen atom other than a fluorine atom; and one or some of fluorine atoms in the perfluoroalkyl group are each optionally substituted by a halogen atom other than a fluorine atom.

3. The plastic optical fiber according to claim 1, wherein
the fluorine-containing polymer is at least one selected from the group consisting of a fluorine-containing polymer A and a fluorine-containing polymer B,
the fluorine-containing polymer A includes a structural unit (C) represented by the following formula (3) and a structural unit (D) represented by the following formula (4): 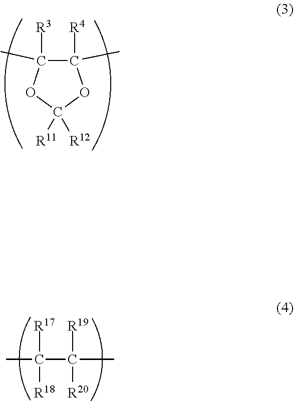
where R¹⁷ to R²⁰ each independently represent a fluorine atom or a perfluoroalkyl group having 1 to 7 carbon atoms; the perfluoroalkyl group optionally has a ring structure; one or some of the fluorine atoms are each optionally substituted by a halogen atom other than a fluorine atom; and one or some of fluorine atoms in the perfluoroalkyl group are each optionally substituted by a halogen atom other than a fluorine atom, and
the fluorine-containing polymer B includes a structural unit (E) represented by the following formula (5):

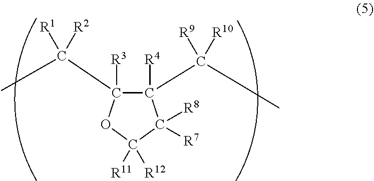

4. The plastic optical fiber according to claim 1, wherein the fluorine-containing polymer includes a structural unit (F) represented by the following formula (6): 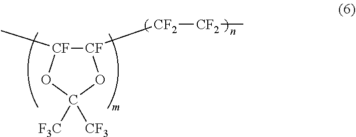
where m and n are each an integer.

5. The plastic optical fiber according to claim 1, wherein the fluorine-containing plasticizer is a fluorine-containing polyether.

6. The plastic optical fiber according to claim 5, wherein the fluorine-containing polyether is a perfluoropolyether.

7. The plastic optical fiber according to claim 1, wherein the fluorine-containing resin has a refractive index of 1.345 or less at a wavelength of 848 nm.

8. The plastic optical fiber according to claim 7, wherein the fluorine-containing resin has a refractive index of 1.325 or less at a wavelength of 848 nm.

9. The plastic optical fiber according to claim 1, wherein a proportion of the fluorine-containing plasticizer to a sum of the fluorine-containing polymer and the fluorine-containing plasticizer is 3 mass % or more and 60 mass % or less.

10. The plastic optical fiber according to claim 1, wherein
the cladding includes a first cladding layer and a second cladding layer,
the first cladding layer is disposed in contact with the core, and
the second cladding layer is disposed closer to an outer circumference of the plastic optical fiber than the first cladding layer is and is formed of the fluorine-containing resin.

11. A plastic optical fiber manufacturing method for manufacturing the plastic optical fiber according to claim 1, the method comprising:
producing a fiber-shaped extrusion-molded body by melting a first preform and extruding the molten first preform into a fiber shape, the first preform including a core material, the fiber-shaped extrusion-molded body being made of the core material; and
coating a surface of the extrusion-molded body with a second preform by melting the second preform and extruding the molten second preform, the second preform including a cladding material, wherein
the cladding material is the fluorine-containing resin.
